(19) United States
(12) Patent Application Publication
(10) Pub. No.: US 2022/0196958 A1
(43) Pub. Date: Jun. 23, 2022

(54) CABLE ARRANGEMENT WITHIN A DATA CENTER

(71) Applicant: COMMSCOPE TECHNOLOGIES LLC, Hickory, NC (US)

(72) Inventors: Earl R. PARSONS, Allen, TX (US); William J. YOUNG, Plano, TX (US)

(73) Assignee: COMMSCOPE TECHNOLOGIES LLC, Hickory, NC (US)

(21) Appl. No.: 17/604,289

(22) PCT Filed: Apr. 14, 2020
(86) PCT No.: PCT/US2020/028107

§ 371 Date: Oct. 15, 2021

Related U.S. Application Data
(60) Provisional application No. 62/834,067, filed on Apr. 15, 2019.

(51) Int. Cl. G02B 6/44; G02B 6/28

(52) U.S. Cl. CPC G02B 6/4471; G02B 6/441; G02B 6/28

(57) ABSTRACT

A cabling arrangement to optically couple data servers to network switches utilizes bidirectional optical fibers (e.g., multi-mode). Some types of cabling arrangements include one or more distribution modules, at least two distribution cables, and a plurality of duplex cables. Other types of cabling arrangement include one or more distribution modules, at least two distribution cables, two configuration modules, a plurality of configuration cables, and a plurality of duplex cables. The cabling arrangement may be passive and/or colorless.

### CROSS-REFERENCE TO RELATED APPLICATION

This application is being filed on Apr. 14, 2020 as a PCT International Patent Application and claims the benefit of U.S. Patent Application Ser. No. 62/834,067, filed on Apr. 15, 2019, the disclosure of which is incorporated herein by reference in its entirety.

### BACKGROUND

In data centers, data servers are mounted on rows of racks. Each rack holds multiple data servers. Typically, a rack switch is mounted to the top of each rack. Each data server in the rack is connected to the rack switch. For example, a data server includes two transceivers that each sends and receives optical signals. A rack switch includes multiple transceivers for sending and receiving optical signals. Each data server transceiver is connected to one of the transceivers of the rack switch. The rack switch is then connected to an optical network using one or more network switch (e.g., tier 1 switches).

Improvements are desired.

### SUMMARY

Some aspects of the disclosure are directed to a cabling arrangement for use within a data center to optically couple data servers to an optical network. A cabling arrangement provides a first optical line to a first network switch and a second optical line to a second network switch. The cabling arrangement includes bidirectional transmission over optical fibers. In some examples, the optical fibers are multi-mode optical fibers. In other examples, the optical fibers are single-mode optical fibers.

In certain examples, the cabling arrangement includes only passive optical components (i.e., is devoid of active electronics).

In certain examples, the cabling arrangement is colorless (i.e., does not utilize wave division multiplexing technology).

In certain examples, a duplex transceiver at a data server sends and receives optical signals to and from two network switch transceivers simultaneously without colored optics or intervening active components.

In certain examples, each multi-mode bidirectional optical fiber carries at least 50 Gb/s data rates bidirectionally.

In some implementations, the cabling arrangement includes one or more distribution modules, at least two distribution cables, and a plurality of duplex cables.

In other implementations, the cabling arrangement includes one or more distribution modules, at least two distribution cables, two configuration modules, a plurality of configuration cables, and a plurality of duplex cables.

A variety of additional inventive aspects will be set forth in the description that follows. The inventive aspects can relate to individual features and to combinations of features. It is to be understood that both the forgoing general description and the following detailed description are exemplary and explanatory only and are not restrictive of the broad inventive concepts upon which the embodiments disclosed herein are based.

### BRIEF DESCRIPTION OF THE DRAWINGS

The accompanying drawings, which are incorporated in and constitute a part of the description, illustrate several aspects of the present disclosure. A brief description of the drawings is as follows:

FIG. 1 shows an example first cabling arrangement suitable for connecting multiple data servers to two network switches, the first cabling arrangement including a distribution module, two distribution cables, and multiple duplex cables.

FIG. 2 is a cabling diagram of an example distribution module suitable for use with the first cabling arrangement of FIG. 1.

FIG. 3 shows an example distribution cable suitable for use with the first cabling arrangement of FIG. 1.

FIG. 4 shows an example duplex cable suitable for use with the first cabling arrangement of FIG. 1.

FIG. 5 shows another example first cabling arrangement including multiple distribution modules.

FIG. 6 shows an example second cabling arrangement suitable for connecting multiple data servers to two network switches, the second cabling arrangement including at least one distribution module, two configuration modules, multiple configuration cables, multiple distribution cables, and multiple duplex cables.

FIG. 7 is a cabling diagram of a first example configuration module suitable for use with the second cabling arrangement of FIG. 6.

FIG. 8 is a cabling diagram of a second example configuration module suitable for use with the second cabling arrangement of FIG. 6.

FIG. 9 shows an example configuration cable suitable for use with the first cabling arrangement of FIG. 6.

FIG. 10 is a cabling diagram of one implementation of the second cabling arrangement of FIG. 6.

FIG. 11 is a cabling diagram of a portion of another implementation of the second cabling arrangement of FIG. 6.

FIG. 12 is a cabling diagram for a data center showing an example second cabling arrangement routed through three racks within the data center.

FIG. 13 is a simplified cabling diagram showing bidirectional, colorless fiber lines extending between a network switch transceiver and a plurality of data server transceivers.

### DETAILED DESCRIPTION

Reference will now be made in detail to exemplary aspects of the present disclosure that are illustrated in the accompanying drawings. Wherever possible, the same reference numbers will be used throughout the drawings to refer to the same or like parts.

The present disclosure is directed to a cabling arrangement for use within a data center to optically couple data servers to an optical network. In particular, the cabling arrangement is configured to route optical signals between network switches and data servers.

In current systems, data servers mounted to a rack are first connected to a rack switch that is typically mounted to the top of the rack. The rack switch is then connected to one or two network switches. While connecting the rack switch to two different network switches provides some redundancy to the system, the rack switch still represents a possible single point of failure. Failure of the rack switch would affect all of the data servers serviced by the rack switch.

The present disclosure is directed to cabling arrangements suitable for replacing the rack switch. Instead, for a data server, a cabling arrangement provides a first optical line to a first network switch and a second optical line to a second network switch. The cabling arrangement includes only passive optical components (i.e., is devoid of active electronics). In certain examples, the cabling arrangement is colorless (i.e., does not utilize wave division multiplexing technology). Some implementations of cabling arrangements includes bidirectional transmission over multi-mode bidirectional optical fibers. Other implementations of cabling arrangements includes bidirectional transmission over single-mode bidirectional optical fibers.

Because the fibers are bidirectional, only one fiber line needs to be routed to a data server per network switch. Accordingly, a duplex port at a data server can send and receive optical signals to and from two network switches simultaneously without colored optics.

In certain examples, each multi-mode bidirectional optical fiber carries at least 50 Gb/s data rates bidirectionally. Accordingly, an 8-fiber multi-mode bidirectional cable can carry data to and from a network switch transmitting at 400 Gb/s. Further, each data server transmit data at a rate of at least 100 Gb/s (e.g., 50 Gb/s per fiber line). It will be understood that other data rates can be used. If one of the network switches fails, some capacity at the data server will be lost, but network traffic will still reach the data server through the other network switch.

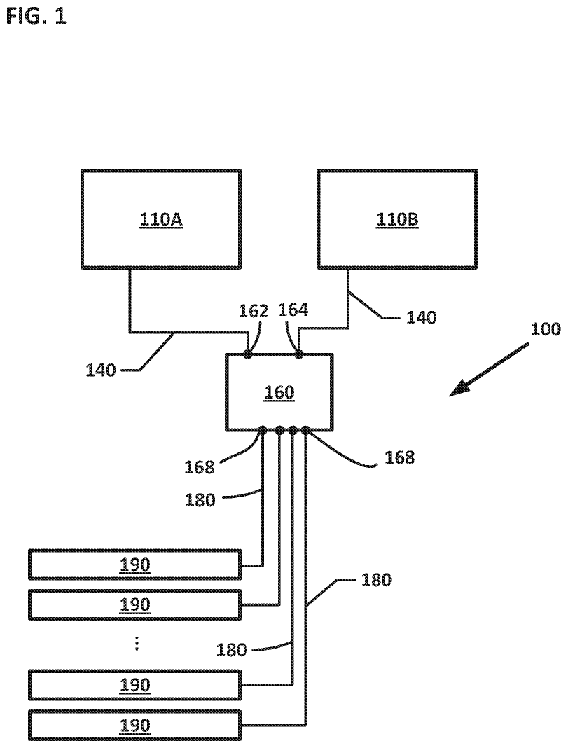

Referring to FIG. 1, a first example cabling arrangement 100 is routed between a first network switch 110, 110A, a second network switch 110, 110B, and multiple data servers 190. The first cabling arrangement 100 carries bidirectional optical signals between the network switches 110 and the data servers 190. In certain examples, the first cabling arrangement 100 carries bidirectional, colorless optical signals between the network switches 110 and the data servers 190. In examples, each cabling arrangement 100 is connected to all data servers 190 in a rack. In an example, each cabling arrangement 100 is connected to data servers 190 in two different racks. In examples, the cabling arrangement 100 services 12, 48, 96, or more data servers.

The cabling arrangement 100 includes at least one distribution module 160, a plurality of distribution cables (e.g., patchcords) 140, and a plurality of duplex cables (e.g., patchcords) 180. The distribution cables 140 are used in optically coupling the distribution module 160 to the network switches 110, 110A, 110B. The duplex cables 180 are used in optically coupling the distribution module 160 to the one or more data servers 190.

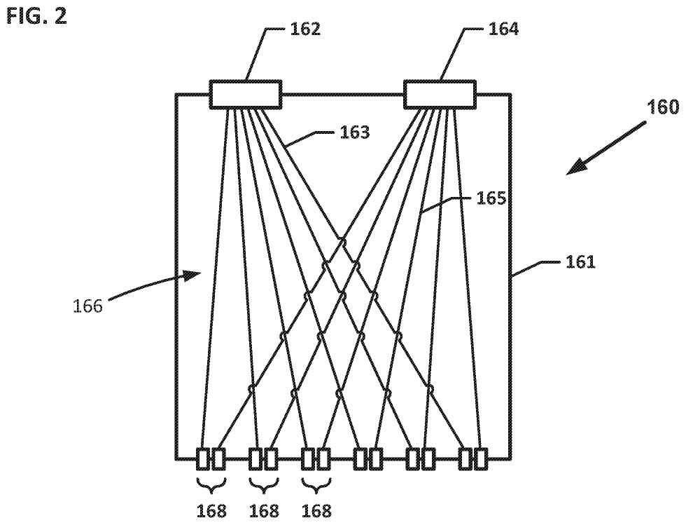

As shown in FIG. 2, an example distribution module 160 includes a housing 161 carrying a first N-fiber connection interface 162, a second N-fiber connection interface 164, and a plurality of duplex connection interfaces 168. An optical circuit 166 within the housing 161 optically couples the connection interfaces as will be described below. In an example, the distribution module 160 has N duplex connection interfaces 168.

As the term is used herein, a “connection interface” can refer to an optical adapter port, a plug connector, or a female connector. As the term is used herein, an “N-fiber connection interface” refers to a connection interface for N live fibers where N is an integer. In certain examples, an N-fiber connection interface is a multi-fiber connection interface. In certain examples, N is greater than 2. In various examples, N can be 4, 8, 12, 16, 24, 32, 48, 96, 144, etc. In certain examples, the N-fiber interface includes an MPO connection interface (e.g., an MPO adapter port or an MPO plug connector). In an example, a 12-fiber connection interface may include an MPO plug connector carrying 12 live fibers. In another example, an 8-fiber connection interface may include an MPO plug connector carrying 8 live fibers and 4 dead fibers. In another example, a 24-fiber connection interface may include an MPO plug connector carrying 24 live fibers.

In certain examples, the first and second N-fiber connection interfaces 162, 164 are defined by external ports of optical adapters (e.g., MPO adapters) mounted to the housing 161. The duplex connection interfaces 168 are defined by external ports of duplex optical adapters (e.g., duplex LC adapters) mounted to the housing 161. In the example shown, the first and second N-fiber connection interfaces 162, 164 are mounted to a first end of the housing 161 and the duplex connection interfaces 168 are mounted to an opposite second end of the housing 161. In other examples, the connection interfaces 162, 164, 168 can be mounted anywhere on the housing.

The internal optical circuit 166 optically couples each duplex connection interface 168 to the first N-fiber connection interface 162 by a respective first fiber line 163 and to the second N-fiber connection interface 164 by a respective second fiber line 165. In certain examples, each fiber line 163, 165 is formed from multi-mode bidirectional optical fiber. In certain examples, each fiber line 163, 165 is formed from single-mode bidirectional optical fiber. For example, the first fiber lines 163 may be grouped at one end and terminated by a multi-fiber connector (e.g., an MPO connector) and plugged into an internally accessible port of the optical adapter defining the first N-fiber connection interface. The second fiber lines 165 may be grouped at one end and terminated by another multi-fiber connector (e.g., an MPO connector) and plugged into an internally accessible port of the optical adapter defining the second N-fiber connection interface. The opposite ends of the first and second fibers lines 163, 165 may be individually connectorized or connectorized in pairs and plugged into internally accessible ports of the optical adapters defining the duplex connection interface.

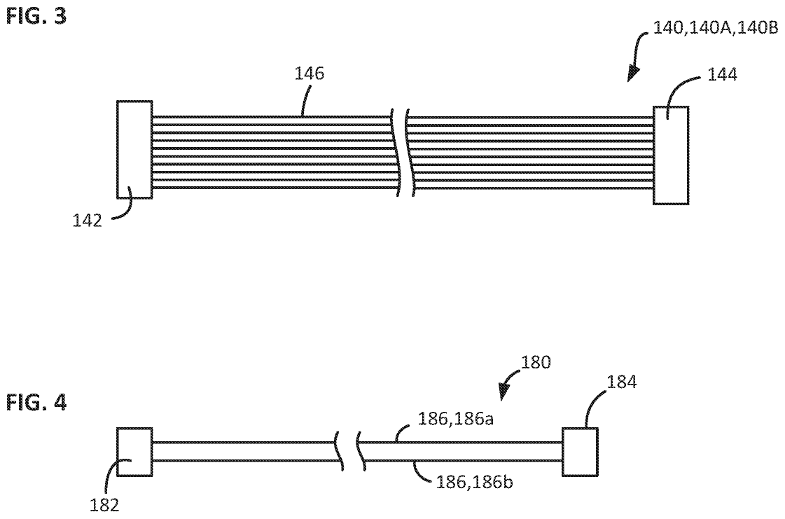

The distribution cables 140 are optically coupled to the N-fiber connection interfaces 162, 164. As shown in FIG. 3, each distribution cable 140 includes N multi-mode or single-mode bidirectional fibers 146 extending between first ends and second ends. The first ends of the N fibers 146 of each distribution cable 140 are configured to optically couple to the network switches 110 (directly or indirectly). For example, FIG. 3 illustrates an example distribution cable 140 implemented as a patchcord so that the first ends of the fibers 146 are terminated at a multi-fiber connection interface 142 and the second ends of the N fibers of each distribution cable 140 are terminated at an N-fiber connection interface 144 adapted to be mated with a respective one of the N-fiber connection interfaces 162, 164 of the distribution module 160. In an example, each distribution cable 140 may be terminated at an N-fiber plug connector 144 that is received in the externally accessible port of the optical adapter defining the respective N-fiber connection interface 162, 164. In another example, each distribution cable 140 can be terminated at an N-fiber female connector that receives a respective N-fiber plug connector carried by the distribution module housing 161.

In the example shown, a first distribution cable 140A optically couples the first network switch 110A to the first N-fiber connection interface 162 of the distribution module 160. A second distribution cable 140B optically couples the second network switch 110B to the second N-fiber connection interface 164 of the distribution module 160. Accordingly, the optical circuit 166 of the distribution module 160 optically couples both network switches 110A, 110B to each duplex connection interface 168.

FIG. 4 illustrates an example duplex cable 180 implemented as a patchcord. As shown in FIG. 4, each duplex cable 180 includes first and second multi-mode bidirectional fibers 186, 186, 186b. In other examples, each duplex cable 180 may include first and second single-mode bidirectional fibers 186, 186, 186b. Each duplex cable 180 has a first end terminated at a first duplex connection interface 182 adapted to be mated with a respective one of the duplex connection interfaces 168 of the distribution module 160. Each duplex cable 180 also has a second end terminated at a second duplex connection interface 184 configured to mate with a respective one of the data servers 190. For example, the second duplex connection interface 184 may include a duplex plug connector (e.g., a duplex LC connector) that plugs into a transceiver at the data server 190.

Referring back to FIG. 1, the first cabling arrangement 100 provides passive, colorless optical lines between the transceivers at multiple network switches 110 and the transceivers at the data servers 190. Accordingly, there is no single point of failure between the network and each data server 190. Further, in certain implementations, no additional transceivers are disposed between the network switches 110 and the data servers 190, which lowers the cost of the overall system. Moreover, the transceivers that are used at the network switches 110 and data servers 190 can be colorless, which also reduces expense compared to colored or wavelength-tunable optics.

In an example, each network switch 110A, 110B may include a plurality of N-fiber ports. The first end 142 of a first distribution cable 140A is plugged into one of the N-fiber ports of the first network switch 110A and the second end 144 is plugged into the first N-fiber connection interface 162 of the distribution module 160. The first end 142 of a second distribution cable 140B is plugged into one of the N-fiber ports of the second network switch 110B and the second end 144 is plugged into the second N-fiber connection interface 164 of the distribution module 160. The first end 182 of each duplex cable 180 is plugged into one of the duplex connection interfaces 168 of the distribution module 160. The second end 184 of each duplex cable 180 is plugged into a transceiver port on a respective one of the data servers 190. Accordingly, for each data server 190, the first cabling arrangement 100 provides a first passive, colorless fiber line to the first network switch 110A and a second passive, colorless fiber line to the second network switch 110B.

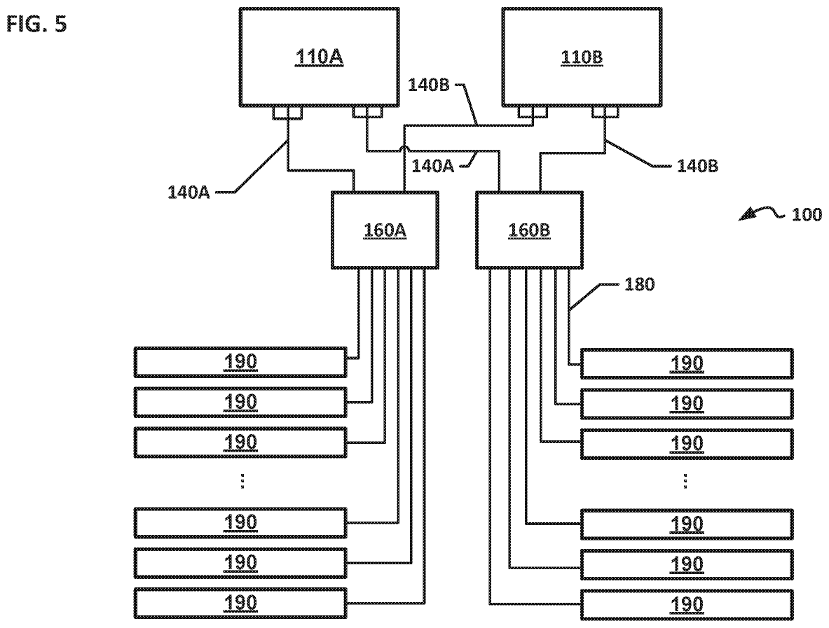

In certain examples, the first cabling arrangement 100 may include multiple distribution modules 160. For example, FIG. 5 shows an example first cabling arrangement 100 including multiple distribution modules 160A, 160B. Each distribution module 160 has a corresponding first and second distribution cable 140A, 140B to connect the respective first and second connection interfaces 162, 164 to the first and second network switches 110A, 110B. Each distribution module 160 provides service for a different group of data servers 190. Accordingly, each distribution module 160 has a corresponding set of duplex cables 180 routed between the respective duplex connection interfaces 168 and the respective data servers 190. In certain examples, the first cabling arrangement 100 can have the same number of distribution modules 160 as ports on the network switches 110.

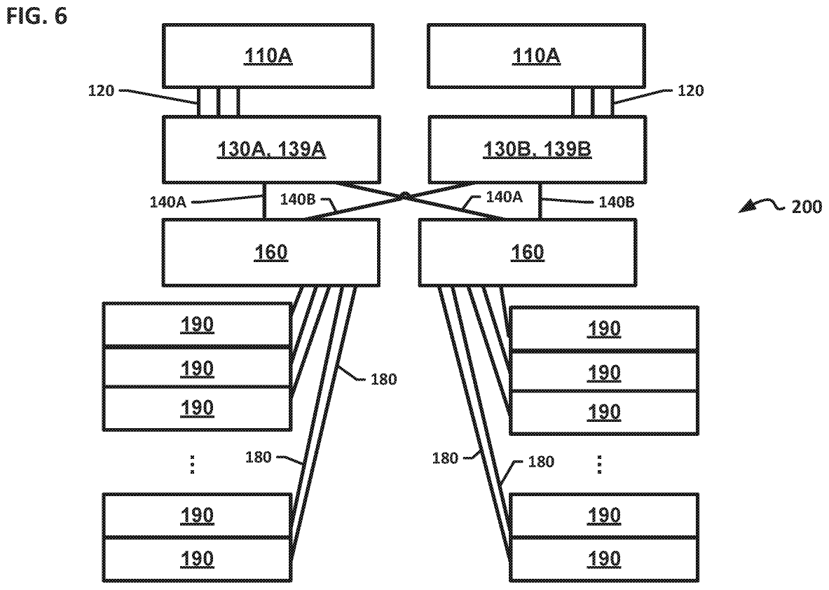

FIG. 6 shows a second example cabling arrangement 200 routed between a first network switch 110, 110A, a second network switch 110, 110B, and multiple data servers 190. The second cabling arrangement 200 carries bidirectional optical signals between the network switches 110 and the data servers 190. In certain examples, the second cabling arrangement 200 carries bidirectional, colorless optical signals between the network switches 110 and the data servers 190. In examples, the second cabling arrangement 200 is connected to all data servers 190 in a rack. In an example, the second cabling arrangement 200 is connected to data servers 190 in two different racks. In examples, the second cabling arrangement 200 services 12, 48, 96, or more data servers 190.

The second cabling arrangement 200 is used when the network switches have M-fiber connection interfaces and the distribution modules 160 have N-fiber connection interfaces. The second cabling arrangement 200 is similar to the first cabling arrangement 100 except that the second cabling arrangement 200 also includes configuration modules 130, 139 and configuration cables (e.g., patchcords) 120 to bridge the M-fiber connection interface and the N-fiber connection interface. For example, the network switches may have multiple 8-fiber connection interfaces while the distribution modules 160 have 12-fiber or 24-fiber connection interfaces.

The second cabling arrangement 200 includes a first configuration module 130, 139 for each network switch 110, a plurality of configuration cables 120, at least one distribution module 160, a plurality of distribution cables 140, and a plurality of duplex cables 180. In general, the configuration cables 120 optically connect the configuration modules 130, 139 to the respective network servers 110, the distribution cables 140 optically connect the configuration modules 130, 139 to the distribution module(s) 160, and the duplex cables 180 optically connect the distribution module(s) 160 to the data servers 190.

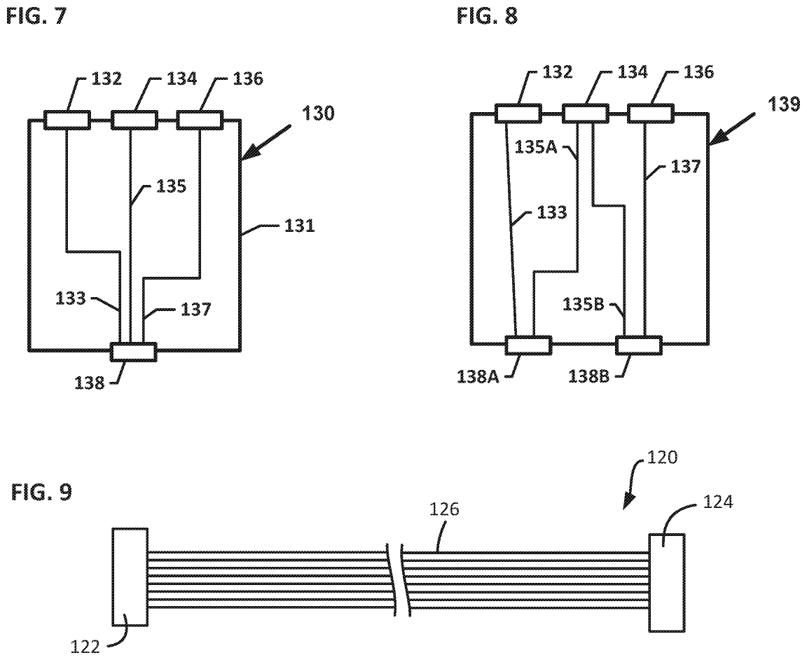

FIGS. 7 and 8 show alternative designs for a configuration module 130, 139. Each configuration module includes a housing 131 holding an optical circuit including bidirectional fibers 133, 135, 137 each extending from one of the M-fiber connection interfaces 132, 134, 136 to an N-fiber connection interface 138. In some examples, the bidirectional fibers 133, 135, 137 are multi-mode fibers. In other examples, the bidirectional fibers 133, 135, 137 are single-mode fibers. In certain examples, M is less than N. Accordingly, the second cabling arrangement 200 can include fewer distribution cables 140 than configuration cables 120 (e.g., since a greater number of fibers are included within each cable). In certain examples, each configuration module 130 includes X M-fiber ports and Y N-fiber ports, where X is greater than Y. In certain configuration modules 130, 139, the connection interfaces are designed so that X*M=Y*N, thereby enhancing the efficiency of the cabling arrangement.

The configuration module 130 shown in FIG. 7 connects three M-fiber connection interfaces 132, 134, 136 with a single N-fiber connection interface 138 via three bidirectional fibers 133, 135, 137, respectively. In some examples, the fibers 133, 135, 137 are multi-mode fibers. In some examples, the fibers 133, 135, 137 are single-mode fibers. In an example, the configuration module 130 connects three 8-fiber connection interfaces to one 24-fiber connection interface 138. The configuration module 139 shown in FIG. 8 routes the fibers extending from three M-fiber connection interfaces 132, 134, 136 to two N-fiber connection interfaces 138. In an example, the configuration module 130 connects three 8-fiber connection interfaces to two 12-fiber connection interfaces 138.

FIG. 9 illustrates an example configuration cable 120 suitable for use in carrying optical signals between the network switches 110 and the configuration modules 130, 139. The configuration cable 120 of FIG. 9 is shown implemented as a patchcord. Each configuration cable 120 includes M bidirectional fibers 126 extending between first ends and second ends. In some examples, the fibers 126 are multi-mode fibers. In other examples, the fibers 126 are single-mode fibers. The first ends of the M fibers 126 of each configuration cable 120 are terminated at a first M-fiber connection interface 122 (e.g., an M-fiber plug connector) adapted to be mated with a respective one of the M-fiber connection interfaces of a network switch 110. The second ends of the M fibers of each configuration cable 120 are terminated at a second M-fiber connection interface 124 adapted to be mated with a respective one of the M-fiber connection interfaces 132, 134, 136 of a configuration module 130, 139. For example, the second end of each configuration cable 120 may be terminated at an M-fiber plug connector 124 that is received in an externally accessible port of an optical adapter defining the respective M-fiber connection interface 132, 134, 136.

Referring back to FIG. 6, in certain implementations, each configuration module 130, 139 is connected to only one of the network switches 110A, 110B using one or more configuration cables 120. Each distribution module 160 is connected to two configuration modules 130, 139 (instead of directly to the network switches) using two distribution cables 140. Accordingly, each distribution module 160 is optically coupled to both network switches 110A, 110B via the configuration modules 130, 139. Each data server 190 is connected to one of the distribution modules 160 using a respective duplex cable 180. In other examples, a greater or fewer number of distribution modules 160 can be used (e.g., one, three, four, eight, ten, twelve, twenty-four, etc.).

The second cabling arrangement 200 provides passive, colorless optical lines between the transceivers 112 at multiple network switches 110 and the transceivers 192 at the data servers 190. Accordingly, there is no single point of failure between the network and each data server 190. Further, in certain implementations, no additional transceivers are disposed between the network switch transceivers 112 and the data server transceivers 192, which lowers the cost of the overall system. Moreover, the transceivers 112, 192 that are used at the network switches 110 and the data servers 190 can be colorless, which also reduces expense compared to colored or wavelength-tunable optics.

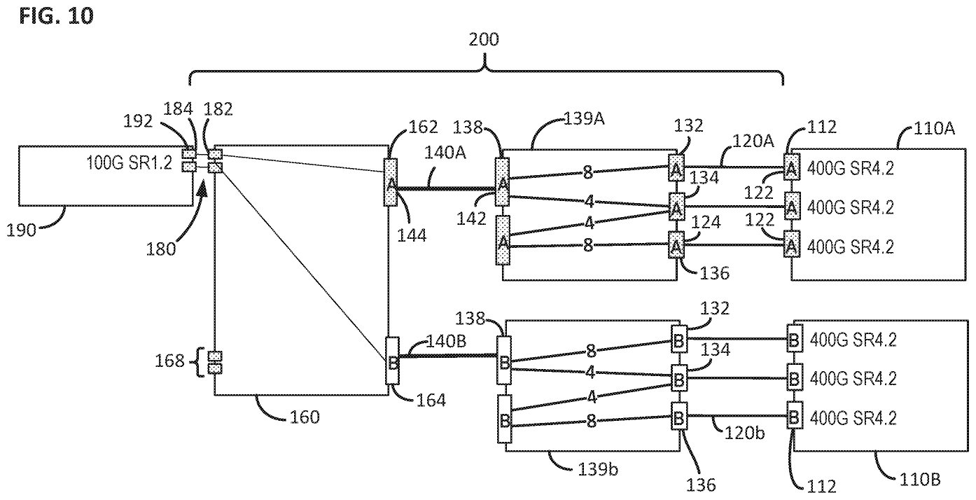

FIG. 10 shows one example implementation of the cabling arrangement 200 that uses the second configuration module 139 to transitions the 8-fiber connection interface 112 at the network switches 110 to 12-fiber connection interfaces to reduce the number of distribution modules 160 and to reduce the number of distribution cables 140 routed to the distribution modules 160.

In FIG. 10, a first network switch 110A and a second network switch 110B each include a plurality of 8-fiber connection interfaces (e.g., 8-fiber ports of a transceiver 112 attached to the network switch). In the example shown, each network switch 110A, 110B has three ports 112. In other examples, however, each network switch 110A, 110B has a greater number of ports (e.g., six, eight, ten, twelve, sixteen, twenty-four, forty-eight, ninety-six, etc.). In an example, each 8-fiber connection interface 112 is a port of a 400GBASE-SR4.2 transceiver transmitting 400 G of data. Corresponding 8-fiber configuration cables 120A, 120B has a first end 122 plugged into one of the transceiver ports 112 of one of the network switches 110A, 110B and a second end 124 plugged into an 8-fiber port 132, 134, 136 of a configuration module 139A, 139B. Each optical fiber 126 of each configuration cable 120 carries 50 G of data in each direction.

Each configuration module 139A, 139B transitions the fiber lines from the configuration cables 120A, 120B onto 12-fiber cables 140A, 140B. In the example shown, each configuration module 139A, 139B transitions all eight fiber lines from the first 8-fiber connection interface 132 to the first 12-fiber connection interface 138, transitions four of the fiber lines from the second 8-fiber connection interface 134 to the first 12-fiber connection interface 138, transitions the other four fiber lines from the second 8-fiber connection interface 134 to the second 12-fiber connection interface 138, and transitions all eight fiber lines from the third 8-fiber connection interface 136 to the second 12-fiber connection interface 138.

A first distribution cable 140A has a first end 142 plugged into the first 12-fiber connection interface 138 at the first configuration module 139A and a second end 144 plugged into the first 12-fiber connection interface 162 of a first distribution module 160. A second distribution cable 140B has a first end 142 connected to the first 12-fiber connection interface 138 at the second configuration module 139A and a second end 144 plugged into the second 12-fiber connection interface 164 of the first distribution module 160. Accordingly, the first distribution module 160 is connected to both network switches 110A, 110B. The first distribution module 160 transitions a fiber line from the first 12-fiber connection interface 162 and a fiber line from the second 12-fiber connection interface 164 to each duplex connection interface 168. Accordingly, the distribution module 160 includes twelve duplex connection interfaces for providing service for up to twelve data servers 190.

Without the configuration modules 139A, 139B, the distribution module would need to have two 8-fiber connection interfaces to receive two 8-fiber distribution cables from the network switches. Accordingly, the distribution module would have only eight duplex connection interfaces for providing service for up to eight data servers 190. Therefore, additional distribution modules would be needed within the system to service the same number of data servers as the cabling arrangement using the configuration modules.

A duplex cable 180 has a first end 182 plugged into one of first duplex connection interfaces 168 of the distribution module 160. A second end 184 of the duplex cable 180 is plugged into a transceiver port 192 at a data server 190. In an example, each transceiver at the data server 190 is an SR1.2 transceiver having a bandwidth of 100 G. The duplex cable 180 carries data signals from the first network switch 110A over a first multi-mode bidirectional fiber 186a and data signals from the second network switch 110B over a second multi-mode bidirectional fiber 186b. In certain examples, the data sever 190 receives 50 G of data over each fiber line 186a, 186b.

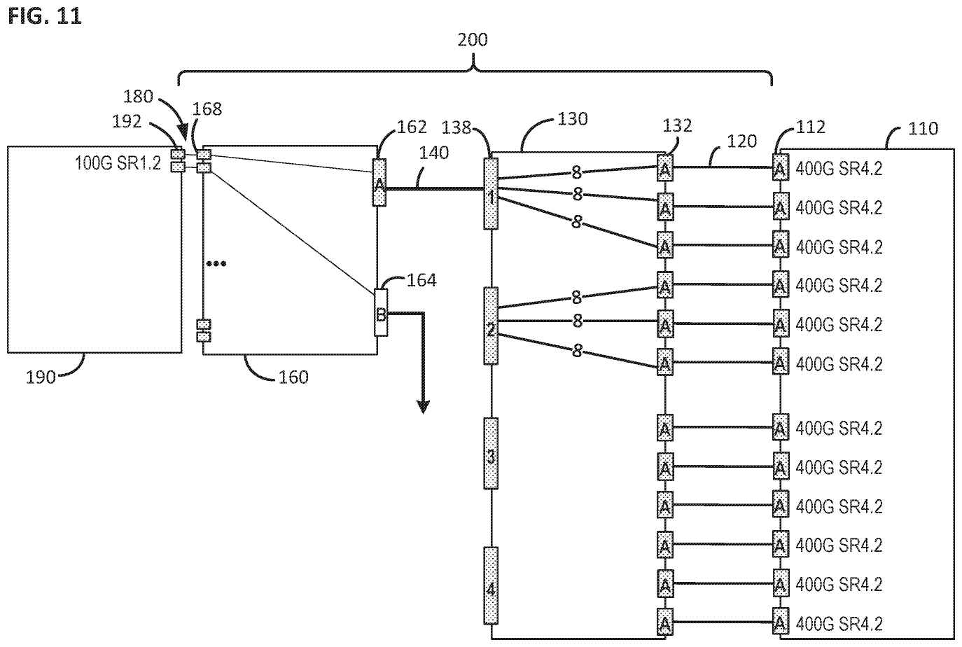

FIG. 11 shows another example implementation of the cabling arrangement 200 that uses a variation of the first configuration module 130 to transitions 8-fiber connection interfaces 112 of the network switches 110 to 24-fiber connection interfaces to further reduce the number of distribution modules 160 and to further reduce the number of distribution cables 140 routed to the distribution modules 160.

In FIG. 11, multiple 8-fiber configuration cables 120A, 120B have first ends 122 plugged into respective ones of the network switch transceiver ports 112 and second ends 124 plugged into 8-fiber ports 132, 134, 136 of a configuration module 130. Each optical fiber 126 of each configuration cable 120 carries 50 G of data. In the example shown, the network switch 110 includes twelve transceiver ports 112. In other examples, the network switch 110 may include a greater or lesser number of ports 112.

The configuration module 130 transitions the fiber lines from the configuration cables 120 onto 24-fiber cables 140. In the example shown, the configuration module 130 transitions all eight fiber lines from the first, second, and third 8-fiber connection interfaces 132, 134, 136 to the first 24-fiber connection interface 138. The configuration module 130 also transitions all eight fiber lines from a fourth, fifth, and sixth 8-fiber connection interface to a second 24-fiber connection interface 138. In some examples, each configuration module 130 has sufficient 8-fiber ports to receive all of the signal traffic of one of the network switches 110. In other examples, multiple configuration modules 130 can service the same network switch 110.

The second network switch and corresponding configuration module are not shown in FIG. 11 for ease in viewing. However, it will be understood that the distribution module 160 receives a first 24-fiber distribution cable 140 from the configuration module 130 of the first network switch 110 and a second 24-fiber distribution cable 140 from the corresponding configuration module 130 of the second network switch. While some of the duplex connection interfaces 168 of the distribution module 160 are not shown for ease in viewing, the distribution module 160 would include twenty-four duplex connection interfaces 168. In the example shown, each configuration module 130 would provide service to four distribution modules 160 via four 24-fiber distribution cables 140.

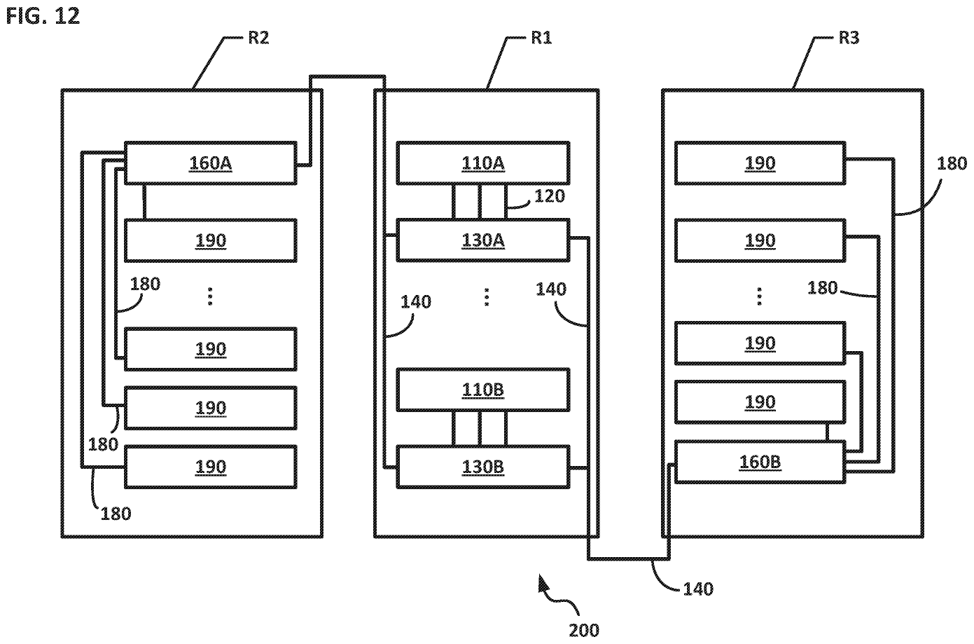

FIG. 12 illustrates the cabling arrangement 200 of FIG. 6 installed on racks in a data center. For ease in viewing, only three of the racks and two of the network switches in the data center are shown. The two network switches 110A, 110B are installed at a first rack R1. In certain examples, the corresponding configuration module(s) 130 for each network switch also are installed at the first rack R1. A first distribution module 160 and corresponding data servers 190 connected to the first distribution module 160 are disposed at a second rack R2. A second distribution module 160 and corresponding data servers 190 connected to the second distribution module 160 are disposed at a third rack R3.

In such a configuration, the duplex cables 180 within the cabling arrangement only need to be routed through one rack instead of between racks. Similarly, the configuration cables 120 also only need to be routed through one rack instead of between racks. Accordingly, the duplex cables 180 and configuration cables 120 can each be relatively short. Only the higher density distribution cables 140 need to be sufficiently long to be routed between racks R1, R2, R3.

In some implementations, the first rack R1 is remote from the second and third racks R2, R3. In certain implementations, the second and third racks R2, R3 are remote from each other. In other implementations, the first, second, and third racks R1-R3 can be adjacent.

It will be understood that additional network switches 110 and configuration modules 130, 139 can be mounted to the rack R1. It will be further understood that each distribution modules 160 could be connected to additional data servers 190 mounted in adjacent or nearby racks. In will also be understood that each pair of network switches 110A, 110B can service multiple distribution modules 160 that each service one or more respective racks of data servers 190.

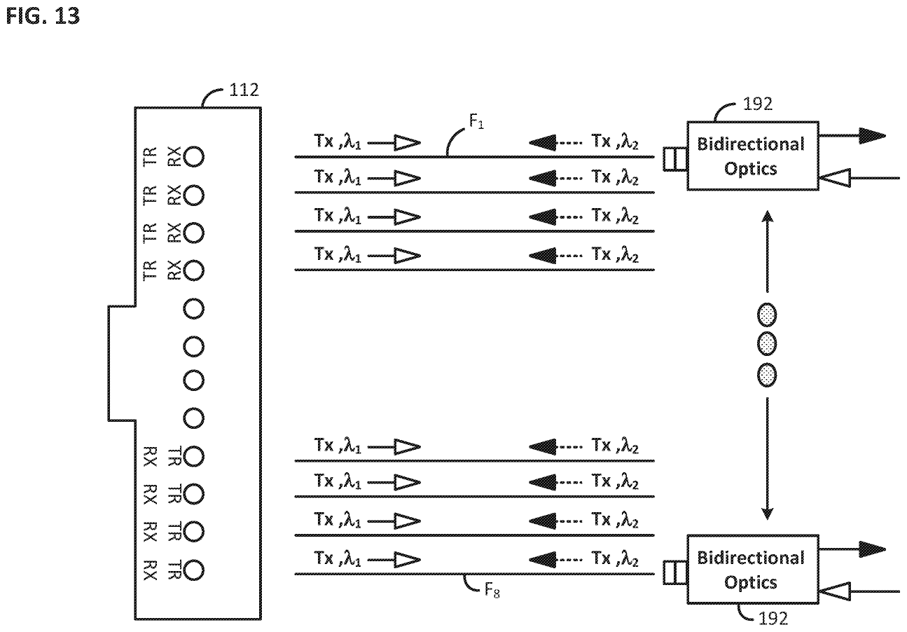

Referring now to FIG. 13, the transceivers 112, 192 at the network switches 110 and data servers 190 can be configured to further enhance the efficiency and cost effectiveness of the network using any of the cabling arrangements disclosed herein. In certain implementations, all transceivers 112 at the network switches 110 may transmit optical signals (e.g., data signals) in a first common wavelength and receive optical signals in a second common wavelength. Accordingly, a common transceiver 112 may be installed at each port of the network switches 110 and a common transceiver 192 may be installed at each data server 190, thereby reducing cost in the network. Moreover, the common transceivers 112, 192 need only be able to transmit in a single wavelength, thereby further reducing cost in the network.

FIG. 13 shows a first transceiver 112 suitable for installation at a first port of a network switch 110. The first transceiver 112 shown has an 8-fiber connection interface. For example, the first transceiver 112 may have an MPO connection interface with eight live fibers. The transceiver transmits data signals over each of the eight live fibers. A first fiber line F1 may be routed through one of the cabling arrangements 100, 200 disclosed herein between the first transceiver 112 and a first data server transceiver 192. The first fiber line F1 is formed from multiple segments of multi-mode bidirectional optical fibers. The first fiber line F1 carries optical signals in a first direction (e.g., from the network switch to the data server) using a first optical wavelength and in a second direction (e.g., from the data server to the network switch) using a second optical wavelength. An eighth fiber line F8 carries optical signals in the first direction using the first optical wavelength and in the second direction using the second optical wavelength.

### Aspects of the Disclosure

Aspect 1. A cabling arrangement for a distribution center to route optical signals between first and second network switches and a plurality of servers, the cabling arrangement comprising:
   a distribution module including a body carrying a first N-fiber connection interface where N is larger than 2, a second N-fiber connection interface, and a plurality of duplex connection interfaces, each duplex connection interface being optically coupled to the first N-fiber connection interface by a respective first multi-mode or single-mode bidirectional fiber and to the second N-fiber connection interface by a respective second multi-mode bidirectional fiber;
   a first cable including N multi-mode or single-mode bidirectional fibers extending between first ends and second ends, the first ends of the N fibers of the first cable being configured to optically couple to the first network switch, the second ends of the N fibers of the first cable being terminated at an N-fiber connection interface adapted to be mated with the first N-fiber connection interface of the distribution module;
   a second cable including N multi-mode or single-mode bidirectional fibers extending between first ends and second ends, the first ends of the N fibers of the second cable being configured to optically couple to the second network switch, the second ends of the N fibers of the second cable being terminated at an N-fiber connection interface adapted to be mated with the second N-fiber connection interface of the distribution module; and
   a plurality of duplex cables each including first and second multi-mode or single-mode bidirectional fibers, each duplex cable having a first end terminated at a first duplex connection interface adapted to be mated with a respective one of the duplex connection interfaces of the distribution module, and each duplex cable having a second end terminated at a second duplex connection interface configured to mate with a respective one of the servers.
Aspect 2. The cabling arrangement of aspect 1, wherein N=8.
Aspect 3. The cabling arrangement of aspect 1, wherein N=12.
Aspect 4. The cabling arrangement of aspect 1, wherein N=24.
Aspect 5. The cabling arrangement of any of aspects 1-4, wherein each of the multi-mode or single-mode bidirectional fibers has a bandwidth of 50 G.
Aspect 6. The cabling arrangement of any of aspects 1-5, wherein the distribution module is devoid of active electronics.
Aspect 7. The cabling arrangement of any of aspects 1-6, wherein the multi-mode bidirectional fibers of the first cable, the multi-mode bidirectional fibers of the second cable, and the multi-mode bidirectional fibers of the duplex cables are colorless.
Aspect 8. The cabling arrangement of any of aspects 1-7, wherein the distribution module is one of a plurality of distribution modules, each distribution module including a respective body carrying a first N-fiber connection interface where N is larger than 2, a second N-fiber connection interface, and a plurality of duplex connection interfaces, each duplex connection interface being optically coupled to the respective first N-fiber connection interface by a respective first multi-mode or single-mode bidirectional fiber and to the respective second N-fiber connection interface by a respective second multi-mode or single-mode bidirectional fiber.
Aspect 9. The cabling arrangement of any of aspects 1-8, wherein the first ends of the N fibers of the first and second cables are terminated at first and second connection interfaces, respectively.
Aspect 10. The cable arrangement of aspect 9, wherein the first connection interface of the first cable is configured to mate with a connection interface of the first network switch, and the second connection interface of the second cable is configured to mate with a connection interface of the second network switch.
Aspect 11. The cable arrangement of aspect 9, further comprising:
   a first configuration module having a plurality of X-fiber connection interfaces and an N-fiber connection interface where X<N, the first configuration module including a plurality of multi-mode or single-mode bidirectional fibers optically coupling the X-fiber connection interfaces of the first configuration module to the N-fiber connection interface of the first configuration module, wherein the first connection interface of the first cable is configured to be received at the N-fiber connection interface of the first configuration module; and
   a second configuration module having a plurality of X-fiber connection interfaces and an N-fiber connection interface, the second configuration module including a plurality of multi-mode or single-mode bidirectional fibers optically coupling the X-fiber connection interfaces of the second configuration module to the N-fiber connection interface of the second configuration module, wherein the second connection interface of the second cable is configured to be received at the N-fiber connection interface of the second configuration module.
Aspect 12. The cable arrangement of aspect 11, further comprising:
   a first configuration cable including X multi-mode or single-mode bidirectional fibers extending between first ends and second ends, the first ends of the X fibers of the first configuration cable being terminated at a first X-fiber connection interface configured to mate with an X-fiber connection interface of the first network switch, the second ends of the X fibers of the first configuration cable being terminated at a second X-fiber connection interface that is mated with a respective one of the X-fiber connection interfaces of the first configuration module; and
   a second configuration cable including X multi-mode or single-mode bidirectional fibers extending between first ends and second ends, the first ends of the X fibers of the second configuration cable being terminated at a first X-fiber connection interface configured to mate with an X-fiber connection interface of the second network switch, the second ends of the X fibers of the second configuration cable being terminated at a second X-fiber connection interface that is mated with a respective one of the X-fiber connection interfaces of the second configuration module.
Aspect 13. The cable arrangement of aspect 12, wherein the first configuration cable is one of a plurality of first configuration cables; and wherein the second configuration cable is one of a plurality of second configuration cables.
Aspect 14. The cable arrangement of any of aspects 1-8, wherein the first ends of the N fibers of the first and second cables are terminated at first and second connection interfaces arrangements, respectively, each connection interface arrangement including a plurality of connection interfaces, each connection interface of the first connection interface arrangement being configured to mate with an connection interface of the first network switch, and each connection interface of the second connection interface arrangement being configured to mate with an connection interface of the second network switch.
Aspect 15. The cabling arrangement of any of aspects 1-14, further comprising a first rack and a second rack; wherein the first network switch and the second network switch are disposed at the first rack; and wherein at least some of the servers are disposed at the second rack.
Aspect 16. The cabling arrangement of aspect 15, wherein at least some of the distribution modules are disposed at the second rack.
Aspect 17. The cabling arrangement of aspect 15, and preferably of claims 11 and 15, wherein the first and second configuration modules are disposed at the first rack.
Aspect 18. The cabling arrangement of any of aspects 15-17, wherein the first rack is not adjacent the second rack.
Aspect 19. The cabling arrangement of any of aspects 1-18, wherein all of the fibers of the cabling arrangement are multi-mode bidirectional fibers.
Aspect 20. A cabling arrangement for a distribution center to route optical signals between first and second network switches and servers, each network switch including a plurality of ports, each port of each network switch having an 8-fiber connection interface, the cabling configuration comprising:
   a first configuration module having X M-fiber connection interfaces and Y N-fiber connection interfaces, wherein Y<X and M<N, the N-fiber connection interfaces of the first configuration module being optically coupled the M-fiber connection interfaces of the first configuration module by multi-mode or single-mode bidirectional fibers disposed within the first configuration module;
   a plurality of first configuration cables, each first configuration cable being routed between a respective port of the first network switch and a respective one of the X M-fiber connection interfaces of the first configuration module, each first configuration cable including M multi-mode or single-mode bidirectional optical fibers;
   a second configuration module having X M-fiber connection interfaces and Y N-fiber connection interfaces, the N-fiber connection interfaces of the second configuration module being optically coupled to the M-fiber connection interfaces of the second configuration module by multi-mode or single-mode bidirectional fibers disposed within the second configuration module;
   a plurality of second configuration cables, each second configuration cable being routed between a respective port of the second network switch and a respective one of the X M-fiber connection interfaces of the second configuration module, each second configuration cable including M multi-mode or single-mode bidirectional optical fibers;
   a distribution module including one or more first N-fiber connection interfaces, one or more second N-fiber connection interfaces, and a plurality of Z-fiber connection interfaces where Z<M, each Z-fiber connection interface of the distribution module being optically coupled to one of the first N-fiber connection interfaces of the distribution module and to one of the second N-fiber connection interfaces of the distribution module by multi-mode or single-mode bidirectional optical fibers disposed within the distribution module;
   a first distribution cable routed between a respective one of the Y N-fiber connection interfaces of the first configuration module and a respective one of the one or more first N-fiber connection interfaces of the distribution module, the first distribution cable including N multi-mode or single-mode bidirectional fibers;
   a second distribution cable routed between a respective one of the Y N-fiber connection interfaces of the second configuration module and a respective one of the one or more second N-fiber connection interfaces of the distribution module, the second distribution cable including N multi-mode or single-mode bidirectional fibers; and
   a plurality of Z-fiber cables, each Z-fiber cable being routed between a respective one of the Z-fiber connection interfaces of the distribution module and an input port of a respective one of the servers, each Z-fiber cable including at least one multi-mode or single-mode bidirectional fiber.
Aspect 21. The cabling arrangement of aspect 20, wherein M=8.
Aspect 22. The cabling arrangement of any of aspects 20 and 21, wherein Z=2.
Aspect 23. The cabling arrangement of any of aspects 20-22, wherein N=12.
Aspect 24. The cabling arrangement of any of aspects 20-23, wherein X=3/2Y.
Aspect 25. The cabling arrangement of any of aspects 20-22, wherein N=24.
Aspect 26. The cabling arrangement of any of aspects 20-25, wherein X=3Y.
Aspect 27. The cabling arrangement of any of aspects 22-26, wherein a first fiber of the Z-fiber cable is a multi-mode or single-mode bidirectional fiber that is optically coupled to the first network switch and a second fiber of the Z-fiber cable is a multi-mode or single-mode bidirectional fiber that is optically coupled to the second network switch.
Aspect 28. The cabling arrangement of claim 20, further comprising a first rack and a second rack, wherein the first network switch, the second network switch, the first configuration module, and the second configuration module are disposed at the first rack, and the distribution module and at least some of the servers are disposed at the second rack.
Aspect 29. The cabling arrangement of aspect 20, wherein the first configuration cables, the second configuration cables, the first distribution cables, the second distribution cables, and the duplex fiber cables are all colorless.
Aspect 30. The cabling arrangement of aspect 20, wherein the first configuration module, the second configuration module, and the distribution module are all devoid of active electronics.
Aspect 31. The cabling arrangement of any of aspects 20-30, wherein all of the fibers of the cabling arrangement are multi-mode bidirectional fibers.
Aspect 32. A cabling configuration for a distribution center to route optical signals between first and second network switches and servers, each network switch including at least three ports, each port of each network switch having an 8-fiber connection interface, each port of each network switch being associated with an SR4 transceiver having a bandwidth of 400 G, the cabling configuration comprising:
   a first configuration module having X 8-fiber connection interfaces and Y N-fiber connection interfaces, wherein Y<X and N>8, the N-fiber connection interfaces of the first configuration module being optically coupled the 8-fiber connection interfaces of the first configuration module by multi-mode or single-mode bidirectional fibers disposed within the first configuration module;
   a plurality of first configuration cables, each first configuration cable being routed between a respective port of the first network switch and a respective one of the X 8-fiber connection interfaces of the first configuration module, each first configuration cable including eight multi-mode or single-mode bidirectional optical fibers each having a bandwidth of 50 G;
   a second configuration module having X 8-fiber connection interfaces and Y N-fiber connection interfaces, the N-fiber connection interfaces of the second configuration module being optically coupled to the 8-fiber connection interfaces of the second configuration module by multi-mode or single-mode bidirectional fibers disposed within the second configuration module;
   a plurality of second configuration cables, each second configuration cable being routed between a respective port of the second network switch and a respective one of the X 8-fiber connection interfaces of the second configuration module, each second configuration cable including eight multi-mode or single-mode bidirectional optical fibers each having a bandwidth of 50 G;
   a plurality of distribution modules each including one or more first N-fiber connection interfaces, one or more second N-fiber connection interfaces, and a plurality of duplex connection interfaces, each duplex connection interface of each distribution module being optically coupled to one of the first N-fiber connection interfaces and to one of the second N-fiber connection interfaces by multi-mode or single-mode bidirectional optical fibers disposed within the respective distribution module;
   a first distribution cable routed between a respective one of the Y N-fiber connection interfaces of the first configuration module and a respective one of the one or more first N-fiber connection interfaces of the distribution module, the first distribution cable including N multi-mode or single-mode bidirectional fibers;
   a second distribution cable routed between a respective one of the Y N-fiber connection interfaces of the second configuration module and a respective one of the one or more second N-fiber connection interfaces of the distribution module, the second distribution cable including N multi-mode or single-mode bidirectional fibers; and
   a plurality of duplex cables, each duplex cable being routed between a respective one of the duplex connection interfaces of the distribution module (160) and an input port of a respective one of the servers, each duplex cable including two multi-mode bidirectional fibers, wherein a first of the two multi-mode or single-mode bidirectional fibers of each duplex cable is optically coupled to the first network switch and a second of the two multi-mode or single-mode bidirectional fibers of each duplex cable is optically coupled to the second network switch.
Aspect 33. A cabling configuration for a distribution center to route optical signals between network switches and servers, the cabling configuration comprising:
   a first rack;
   a first network switch mounted at the first rack, the first network switch including
   at least three ports, each port of the first network switch having an 8-fiber MPO connection interface, each port of the first network switch being associated with a 400GBASE-SR4.2 transceiver;
   a first configuration module mounted at the first rack, the first configuration module having at least three input ports, a first output port, and a second output port;
   at least three first cables routed between the at least three ports of the first network switch and the at least three input ports of the first configuration module, each first cable including eight multi-mode bidirectional optical fibers, each multi-mode bidirectional optical fiber having a bandwidth of 50 G;
   the first configuration module routing optical signals from a first half of the optical fibers of the at least three first cables to the first output port of the first configuration module and routing optical signals from a second half of the optical fibers of the at least three first cables to the second output port of the first configuration module;
   a second network switch mounted at the first rack, the second network switch including at least three ports, each port of the second network switch having an 8-fiber MPO connection interface, each port of the second network switch being associated with an SR4 transceiver having a bandwidth of 400 G;
   a second configuration module mounted at the first rack, the second configuration module having at least three input ports, a first output port, and a second output port;
   at least three second cables routed between the at least three ports of the second network switch and the at least three input ports of the second configuration module, each second cable including eight multi-mode bidirectional optical fibers, each multi-mode bidirectional optical fiber having a bandwidth of 50 G;
   the second configuration module routing optical signals from a first half of the optical fibers of the at least three second cables to the first output port of the second configuration module and routing optical signals from a second half of the optical fibers of the at least three second cables to the second output port of the second configuration module;
   a second rack;
   a first distribution module mounted at the second rack, the first distribution module including a first input port, a second input port, and a plurality of output ports, each of the first and second input ports of the first distribution module including a 12-fiber or 24-fiber MPO connection interface, each output port of the first distribution module including a duplex LC connection interface, each output port of the first distribution module being optically coupled to both the first input port of the first distribution module and to the second input port of the first distribution module;
   a first distribution cable routed between the first output port of the first configuration module and the first input port of the first distribution module, the first distribution cable including 12 or 24 multi-mode bidirectional fibers;
   a second distribution cable routed between the first output port of the second configuration module and the second input port of the first distribution module, the second distribution cable including 12 or 24 multi-mode bidirectional fibers;
   a plurality of first servers mounted at the second rack, each first server including an input port having a duplex LC interface, the input port of each first server being associated with an SR1.2 transceiver;
   a plurality of first duplex fiber cables, each first duplex fiber cable being routed between a respective output port of the first distribution module and the input port of a respective one of the first servers, each first duplex fiber cable including two multi-mode bidirectional fibers, wherein a first of the two multi-mode bidirectional fibers of each first duplex fiber cable is optically coupled to the first network switch and a second of the two multi-mode bidirectional fibers of each first duplex fiber cable is optically coupled to the second network switch;
   a third rack;
   a second distribution module mounted at the third rack, the second distribution module including a first input port, a second input port, and a plurality of output ports, each of the first and second input ports of the second distribution module including a 12-fiber or 24-fiber MPO connection interface, each output port of the second distribution module including a duplex LC connection interface, each output port of the second distribution module being optically coupled to both the first input port of the second distribution module and to the second input port of the second distribution module;
   a third distribution cable routed between the second output port of the first configuration module and the first input port of the second distribution module, the third distribution cable including 12 or 24 multi-mode bidirectional fibers;
   a fourth distribution cable routed between the second output port of the second configuration module and the second input port of the second distribution module, the fourth distribution cable including 12 or 24 multi-mode bidirectional fibers;
   a plurality of second servers mounted at the third rack, each second server including an input port having a duplex LC interface, the input port of each second server being associated with an SR1.2 transceiver; and
   a plurality of second duplex fiber cables, each second duplex fiber cable being routed between a respective output port of the second distribution module and the input port of a respective one of the second servers, each second duplex fiber cable including two multi-mode bidirectional fibers, wherein a first of the two multi-mode bidirectional fibers of each second duplex fiber cable is optically coupled to the first network switch and a second of the two multi-mode bidirectional fibers of each second duplex fiber cable is optically coupled to the second network switch.
Aspect 34. A cabling configuration for a distribution center to route optical signals between network switches and servers, the cabling configuration comprising:
   a first rack;
   a first network switch mounted at the first rack, the first network switch including at least three ports, each port of the first network switch having an 8-fiber MPO connection interface, each port of the first network switch being associated with a 400GBASE-SR4.2 transceiver;
   a second network switch mounted at the first rack, the second network switch including at least three ports, each port of the second network switch having an 8-fiber MPO connection interface, each port of the second network switch being associated with a 400GBASE-SR4.2 transceiver;
   a second rack;
   a first distribution module mounted at the second rack, the first distribution module including a first group of one or more input ports, a second group of one or more input ports, and a plurality of output ports, each of the input ports of the first and second groups of the first distribution module including a 12-fiber or 24-fiber MPO connection interface, each output port of the first distribution module including a duplex LC connection interface, each output port of the first distribution module being optically coupled to one of the input ports of the first group and to one of the input ports of the second group;
   a plurality of first distribution cables, each first distribution cable being routed between a respective one of the ports of the first network switch and one of the input ports of the first group of the first distribution module, each first distribution cable including 8 multi-mode bidirectional fibers, each of the 8 multi-mode bidirectional optical fibers having a bandwidth of 50 G;
   a plurality of second distribution cables, each second distribution cable being routed between a respective one of the ports of the second network switch and one of the input ports of the second group of the first distribution module, each second distribution cable including 8 multi-mode bidirectional fibers, each of the 8 multi-mode bidirectional optical fibers having a bandwidth of 50G;
   a plurality of first servers mounted at the second rack, each first server including an input port having a duplex LC interface, the input port of each first server being associated with an SR1.2 transceiver;
   a plurality of first duplex fiber cables, each first duplex fiber cable being routed between a respective output port of the first distribution module and the input port of a respective one of the first servers, each first duplex fiber cable including two multi-mode bidirectional fibers, wherein a first of the two multi-mode bidirectional fibers of each first duplex fiber cable is optically coupled to the first network switch and a second of the two multi-mode bidirectional fibers of each first duplex fiber cable is optically coupled to the second network switch;
   a third rack;
   a second distribution module mounted at the third rack, the second distribution module including a first group of one or more input ports, a second group of one or more input ports, and a plurality of output ports, each of the input ports of the first and second groups of the second distribution module including a 12-fiber or 24-fiber MPO connection interface, each output port of the second distribution module including a duplex LC connection interface, each output port of the second distribution module being optically coupled to one of the input ports of the first group of the second distribution module and to one of the input ports of the second group of the second distribution module;
   a plurality of third distribution cables, each third distribution cable being routed between a respective one of the ports of the first network switch and one of the input ports of the first group of the second distribution module, each third distribution cable including 8 multi-mode bidirectional fibers, each of the 8 multi-mode bidirectional optical fibers having a bandwidth of 50 G;
   a plurality of fourth distribution cables, each fourth distribution cable being routed between a respective one of the ports of the second network switch and one of the input ports of the second group of the second distribution module, each fourth distribution cable including 8 multi-mode bidirectional fibers, each of the 8 multi-mode bidirectional optical fibers having a bandwidth of 50 G;
   a plurality of second servers mounted at the third rack, each second server including an input port having a duplex LC interface, the input port of each second server being associated with an SR1.2 transceiver; and
   a plurality of second duplex fiber cables, each second duplex fiber cable being routed between a respective output port of the second distribution module and the input port of a respective one of the second servers, each second duplex fiber cable including two multi-mode bidirectional fibers, wherein a first of the two multi-mode bidirectional fibers of each second duplex fiber cable is optically coupled to the first network switch and a second of the two multi-mode bidirectional fibers of each second duplex fiber cable is optically coupled to the second network switch.
Aspect 35. A cabling configuration for a distribution center to route optical signals between network switches and servers, the cabling configuration comprising:
   a first network switch including a plurality of ports, each port of the first network switch having an MPO connection interface and being associated with a 400GBASE-SR4.2 transceiver;
   a second network switch including a plurality of ports, each port of the second network switch having an MPO connection interface and being associated with a 400GBASE-SR4.2 transceiver;
   a plurality of distribution modules, each distribution module including a first group of one or more input ports, a second group of one or more input ports, and a plurality of output ports, each of the input ports of the first and second groups of each distribution module including an MPO connection interface, each output port of each distribution module including a duplex LC connection interface, each output port of each distribution module being optically coupled to one of the input ports of the respective first group and to one of the input ports of the respective second group;
   a plurality of first distribution cables, each first distribution cable being routed between a respective one of the ports of the first network switch and a respective input port of the first group of a respective one of the distribution modules, each first distribution cable including multi-mode bidirectional fibers;
   a plurality of second distribution cables, each second distribution cable being routed between a respective one of the ports of the second network switch and a respective input port of the second group of a respective one of the distribution modules, each second distribution cable including multi-mode bidirectional fibers;
   a plurality of servers, each of the servers including an input port having a duplex LC interface, the input port of each of the servers being associated with an SR1.2 transceiver; and
   a plurality of duplex fiber cables, each duplex fiber cable being routed between a respective output port of a respective one of the distribution modules and the input port of a respective one of the servers, each duplex fiber cable including two multi-mode bidirectional fibers, wherein a first of the two multi-mode bidirectional fibers of each duplex fiber cable is optically coupled to the first network switch and a second of the two multi-mode bidirectional fibers of each duplex fiber cable is optically coupled to the second network switch.

It is noted that the terms “output” and “input” used above are not meant to be limiting. Since each fiber line of the cabling arrangements 100, 200 is bidirectional, the terms output and input are used merely for convenience to indicate switch side (input) and data server side (output) of the various modules. Signals transmitted by the data servers can be received at the outputs of the modules and carried through the inputs to the network switches.

Having described the preferred aspects and implementations of the present disclosure, modifications and equivalents of the disclosed concepts may readily occur to one skilled in the art. However, it is intended that such modifications and equivalents be included within the scope of the claims which are appended hereto.

1. A cabling arrangement for a distribution center to route optical signals between first and second network switches and a plurality of servers, the cabling arrangement comprising:
a distribution module including a body carrying a first N-fiber connection interface where N is larger than 2, a second N-fiber connection interface, and a plurality of duplex connection interfaces, each duplex connection interface being optically coupled to the first N-fiber connection interface by a respective first bidirectional fiber and to the second N-fiber connection interface by a respective second bidirectional fiber;
a first cable including N bidirectional fibers extending between first ends and second ends, the first ends of the N fibers of the first cable being configured to optically couple to the first network switch, the second ends of the N fibers of the first cable being terminated at an N-fiber connection interface adapted to be mated with the first N-fiber connection interface of the distribution module;
a second cable including N bidirectional fibers extending between first ends and second ends, the first ends of the N fibers of the second cable being configured to optically couple to the second network switch, the second ends of the N fibers of the second cable being terminated at an N-fiber connection interface adapted to be mated with the second N-fiber connection interface of the distribution module; and
a plurality of duplex cables each including first and second bidirectional fibers, each duplex cable having a first end terminated at a first duplex connection interface adapted to be mated with a respective one of the duplex connection interfaces of the distribution module, and each duplex cable having a second end terminated at a second duplex connection interface configured to mate with a respective one of the servers.

2. The cabling arrangement of claim 1, wherein N=8.

3. The cabling arrangement of claim 1, wherein N=12.

4. The cabling arrangement of claim 1, wherein N=24.

5. The cabling arrangement of claim 1, wherein each of the bidirectional fibers has a bandwidth of 50 G.

6. The cabling arrangement of claim 1, wherein the distribution module is devoid of active electronics.

7. The cabling arrangement of claim 1, wherein the bidirectional fibers of the first cable, the bidirectional fibers of the second cable, and the bidirectional fibers of the duplex cables are colorless.

8. The cabling arrangement of claim 1, wherein the distribution module is one of a plurality of distribution modules, each distribution module including a respective body carrying a first N-fiber connection interface where N is larger than 2, a second N-fiber connection interface, and a plurality of duplex connection interfaces, each duplex connection interface being optically coupled to the respective first N-fiber connection interface by a respective first bidirectional fiber and to the respective second N-fiber connection interface by a respective second bidirectional fiber.

9. The cabling arrangement of claim 1, wherein the first ends of the N fibers of the first and second cables are terminated at first and second connection interfaces, respectively.

10. The cable arrangement of claim 9, wherein the first connection interface of the first cable is configured to mate with an output connection interface of the first network switch, and the second connection interface of the second cable is configured to mate with an output connection interface of the second network switch.

11. The cable arrangement of claim 9, further comprising:
a first configuration module having a plurality of X-fiber connection interfaces and an N-fiber connection interface where X<N, the first configuration module including a plurality of bidirectional fibers optically coupling the X-fiber connection interfaces of the first configuration module to the N-fiber connection interface of the first configuration module, wherein the first connection interface of the first cable is configured to be received at the N-fiber connection interface of the first configuration module; and
a second configuration module having a plurality of X-fiber connection interfaces and an N-fiber connection interface, the second configuration module including a plurality of bidirectional fibers optically coupling the X-fiber connection interfaces of the second configuration module to the N-fiber connection interface of the second configuration module, wherein the second connection interface of the second cable is configured to be received at the N-fiber connection interface of the second configuration module.

12. The cable arrangement of claim 11, further comprising:
a first configuration cable including X bidirectional fibers extending between first ends and second ends, the first ends of the X fibers of the first configuration cable being terminated at a first X-fiber connection interface configured to mate with an X-fiber output of the first network switch, the second ends of the X fibers of the first configuration cable being terminated at a second X-fiber connection interface that is mated with a respective one of the X-fiber connection interfaces of the first configuration module; and
a second configuration cable including X bidirectional fibers extending between first ends and second ends, the first ends of the X fibers of the second configuration cable being terminated at a first X-fiber connection interface configured to mate with an X-fiber output of the second network switch, the second ends of the X fibers of the second configuration cable being terminated at a second X-fiber connection interface that is mated with a respective one of the X-fiber connection interfaces of the second configuration module.

13. The cable arrangement of claim 12, wherein the first configuration cable is one of a plurality of first configuration cables; and wherein the second configuration cable is one of a plurality of second configuration cables.

14. The cable arrangement of claim 1, wherein the first ends of the N fibers of the first and second cables are terminated at first and second connection interfaces arrangements, respectively, each connection interface arrangement including a plurality of connection interfaces, each connection interface of the first connection interface arrangement being configured to mate with an output connection interface of the first network switch, and each connection interface of the second connection interface arrangement being configured to mate with an output connection interface of the second network switch.

15. The cabling arrangement of claim 1, further comprising a first rack and a second rack; wherein the first network switch and the second network switch are disposed at the first rack; and wherein at least some of the servers are disposed at the second rack.

16. The cabling arrangement of claim 15, wherein at least some of the distribution modules are disposed at the second rack.

17. The cabling arrangement of claim 11, further comprising a first rack and a second rack; wherein the first network switch and the second network switch are disposed at the first rack; and wherein at least some of the servers are disposed at the second rack, and wherein the first and second configuration modules are disposed at the first rack.

18. The cabling arrangement of claim 15, wherein the first rack is not adjacent the second rack.

19. The cabling arrangement of claim 1, wherein the first and second bidirectional fibers of the distribution module are multi-mode bidirectional fibers, the first and second cables each include N multi-mode bidirectional fibers, and the duplex cables each include first and second multi-mode bidirectional fibers.

20. The cabling arrangement of claim 1, wherein the bidirectional fibers of the first and second configuration module include multi-mode bidirectional fibers.

21.-32. (canceled)
